(19) United States
(12) Patent Application Publication
(10) Pub. No.: US 2022/0202026 A1
(43) Pub. Date: Jun. 30, 2022

(54) SHREDDED DRIED FOOD PRODUCTS

(71) Applicant: Ju Han Steve Song, Los Angeles, CA (US)

(72) Inventor: Ju Han Steve Song, Los Angeles, CA (US)

(21) Appl. No.: 17/698,330

(22) Filed: Mar. 18, 2022

Related U.S. Application Data
(63) Continuation-in-part of application No. 15/442,565, filed on Feb. 24, 2017.

(51) Int. Cl. A23B 4/03

(52) U.S. Cl. CPC A23B 4/03

(57) ABSTRACT

A method of producing shredded, dried food products is provided. The method begins when a food type such as beef, pork, or chicken, or may be a fibrous vegetable, such as mushrooms. The selected food type is first heated to tenderize the food. In the case of meats, this tenderizing breaks down fibrous tissue in the food, making for easier to chew and digest. After cooking to tenderize, the food is then shredded. This shredding leaves strands of the food and does not cut across fibers, instead, the shredding follows the muscle or growing pattern of the food type. The shredded food product is then boiled for further tenderization. Flavorings may also be added during the boiling process. After boiling, the food product is dried to reduce the moisture content to a desired level.

### CROSS-REFERENCE TO RELATED APPLICATIONS

This application is a Continuation in Part of U.S. Non-Provisional patent application Ser. No. 15/442,565 filed on Feb. 24, 2017, titled “SHREDDED DRIED FOOD PRODUCT”, by inventor Ju Han Steve Song, the contents of which are expressly incorporated herein by this reference and to which priority is claimed.

### FIELD

The present disclosure relates generally to food processing and has particular utility in connection with processing food to produce shredded meat, fish or vegetable food products.

### BACKGROUND

Dried food products are used by many individuals to provide a quick snack or to supplement a meal. Outdoor enthusiasts have relied on dried and prepared meats when camping or hiking. Beef jerky was supplied to astronauts as a snack food. Many of these dried food products have been dried meats, in many cases, cured with salt. These dried foods may have a moisture content around 25-40%, while jerky-style products may have a moisture content around 15-30%. Many of these products have a hard, dry texture and are difficult to chew.

Many cultures have prepared such dried foods. Beef jerky has been known in the United States for many years and was produced by Native Americans, as well as European settlers. Pemmican, produced by the Native Americans, is widely known. Asian cultures also have a tradition of dried meats, such as meat floss, also known as rousong. Rousong has been produced with a variety of meats including beef and pork. Typically, rousong is a dried pork product having a light and fluffy texture, similar to that of coarse cotton. In Chinese cuisine rousong has been used as a topping for many foods, as a filling in buns and pastries, and as a snack food.

Today, many people live an active lifestyle and need meals that are easy to prepare, flavorful, and healthy. Because many of the dried snack products, especially meats, are cured and dried, the sodium content may be higher than other foods. For health reasons, many individuals must keep careful track of their sodium intake and while they may like the flavor and convenience of the jerky-type products, they may not use them often. Fat content may also be a concern, and many dried food products do not reduce the fat content. The elderly may need products that are easy to chew and digest. Very dry meats, such as jerky, may be difficult for them to chew as they may be very hard.

There is a need in the art for a food product that is healthy, flavorful, easy to store for long periods, and is easy to chew and digest.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

Embodiments described herein provide a method of producing shredded, dried food products. The method begins when a food type is selected. The food type may be a meat such as beef, pork, or chicken, or may be a fibrous vegetable, such as mushrooms. The selected food type is first heated to tenderize the food. In the case of meats, this tenderizing breaks down fibrous tissue in the food, making for easier to chew and digest. After cooking to tenderize, the food is then shredded. This shredding leaves strands of the food and does not cut across fibers, instead, the shredding follows the muscle or growing pattern of the food type. The shredded food product is then boiled for further tenderization. Some vegetables may not need further tenderization. Flavorings may also be added during the boiling process. After boiling, the food product is dried to reduce the moisture content to a desired level. This level of dryness may vary depending on the intended use of the food product and the desired storage time.

One embodiment may be a method of making a shredded, dried food product, the method comprising the follow steps in order: (a) selecting a food type; (b) cooking the food type and a marinade to a desired temperature to tenderize the food type in a first cooking process, wherein the first cooking process cooks with the marinade in a wet cooking process; (c) partially drying the food product to further tenderize the food product with a second cooking process wherein the second cooking process cooks without the marinade in a dry cooking process in a second cooking vessel while the food product is held in a first position and then rotated into a second position to avoid burning or over cooking and pressing the food product lightly to further tenderize the food product and to add air which extracts some moisture; (d) shredding the food product after the first cooking process at a shredding station creating a texture between a sliced jerky product and extremely fine filaments of a meat floss; and (e) drying the food product to reduce a moisture content of the food product to a select value. The method may further comprise: slicing along the muscle fibers the selected food product into strips before heating the food type to the desired temperature. The method may further comprise: marinating the food type before heating or cooking the food type to a desired temperature to tenderize the food type. The marinade may contain at least two of the following: a salt, an acid, and a flavor component. In some embodiments, the marinade may be a brine solution. The first cooking process may be a slow cooking process, boiling, and/or pressure cooking. The second cooking process is preferably different from the first cooking process.

Another embodiment may be a method of producing a shredded, dried meat product, the method comprising the follow steps in order: (a) selecting a type of meat; (b) slicing the meat along a muscle line to produce slices; (c) marinating the slices in a marinade solution; (d) cooking the marinated slices in a first cooking process until a selected temperature is reached, wherein the first cooking process is a dry cooking process in a first cooking vessel; (e) partially drying the shredded meat with a reserved marinade solution with a second cooking process, wherein the second cooking process cooks with the reserved marinade in a second cooking vessel while the shredded meat is held in a first position and then rotated into a second position to avoid burning or over cooking and pressing the shredded meat lightly to further tenderize the food product and to add air which extracts some moisture; (f) shredding the food product after the first cooking process at a shredding station creating a texture between a sliced jerky product and extremely fine filaments of a meat floss; and g) drying the food product to reduce a moisture content of the food product to a select value. The selected dryness is within a range of 5% moisture to 99% moisture. The cooking the meat to a selected dryness in a third cooking process may include turning the meat during the cooking.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flowchart of an overview of a method for producing a shredded dried food product, in accordance with certain embodiments of the disclosure.

FIG. 2 is a block diagram of a food processing system in accordance with embodiments of the disclosure.

FIG. 3 illustrates cutting preferences in accordance with embodiments of the disclosure.

FIG. 4 illustrates possible shredding process options after initial cooking, in accordance with certain embodiments of the disclosure.

FIG. 5 depicts chilled fats and oils after cooling, in accordance with certain embodiments of the disclosure.

FIG. 6 shows straining of the cooking juices and marinade, in accordance with certain embodiments of the disclosure.

FIG. 7A shows the finished food product, in accordance with certain embodiments of the disclosure.

FIG. 7B shows a close up of the finished food product, in accordance with certain embodiments of the disclosure.

FIG. 8 is a flow diagram of a method of producing a shredded, dried food product, in accordance with certain embodiments of the disclosure.

FIG. 9 is a flow diagram of one embodiment of the method of producing a shredded and dried food product.

FIG. 10A is an image of one embodiment of a shredding device.

FIG. 10B is an image of another embodiment of a shredding device.

FIG. 10C is an image of another embodiment of a shredding device.

FIG. 10D is an image of another embodiment of a shredding device.

FIG. 11A is an image of one embodiment of a tumble dryer.

FIG. 11B is an image of another embodiment of the tumble dryer.

FIG. 12A is an image of a one embodiment of an oven.

FIG. 12B is an image of a one embodiment of an oven rack.

FIG. 13 is an image of a prior art conveyor heater.

FIG. 14 is an image of a prior art meat floss machine.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

Several specific details of the invention are set forth in the following description and in the Figures to provide a thorough understanding of embodiments of the disclosure. One skilled in the art, however, will understand that the disclosure may additional embodiments, and that other embodiments of the disclosure may be practiced without several of the specific features or processes described below.

Other aspects, as well as features and advantages of various aspects, of the present invention will become apparent to those of skill in the art through consideration of the ensuring description, the accompanying drawings and the appended claims.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-40% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details.

### Overview

The present disclosure describes a shredded, dried food product and methods and systems for making such products. The food product refers to animal flesh, such as beef, pork, lamb, chicken, turkey, rabbit, fish, shellfish, and may also refer to a vegetable product.

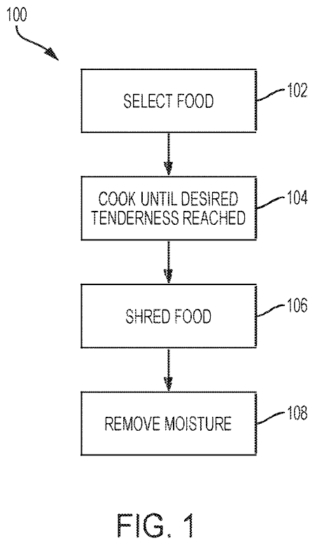

FIG. 1 is a flowchart of a basic method used to prepare a shredded, dried food product. The method, 100, begins in step 102 when the food or meat is selected. One embodiment uses an animal meat such as beef, chicken, or fish. The food selected may also be any fibrous textured vegetable such as mushrooms. Once the meat has been selected it is prepared for cooking, if necessary. For some meats, such as beef, slicing may be used to ensure that uniform cooking and marinating occurs. Other meats, such as chicken or fish, may be used whole for the initial preparation. The selected meat is then cooked in step 104 until a desired tenderness is reached. Certain vegetables may skip this process and go straight to shredding. Vegetables that may be directly shredded include: mushrooms, seaweed, lotus root, broccoli stems, and okra, to name a few. Some vegetables such as squash, carrots, yams, and zucchini may be julienned (a technique resulting in thin stick-like cuts). This initial cooking may use a variety of cooking techniques such as boiling, baking, pressure cooking, steaming or slow cooking. This initial cooking breaks down the fibers of the meat and tenderizes the meat. After initial cooking, the meat may be cooled and then shredded in step 106. This shredding is carefully performed to create the unique texture of the product. The desired texture is not chunky or sliced like a jerky product, nor is it the extremely fine filaments of a meat floss. The shredding allows the original character of the meat to remain, while providing a tender product. Once shredded the meat is dried to remove moisture in step 108. Additional flavorings, seasonings, or marinates may be added during steps 104, 106, and 108.

Another embodiment of the disclosure provides for a marinated or flavored shredded dried food product. This embodiment may also provide a vegetable product. A fibrous vegetable may be selected and then processed as described in FIG. 1 above. A further embodiment may provide for marinating in a flavored or seasoned broth and then reserving the marinade and cooking juices for the drying step to provide additional flavoring.

### Shredded Dried Food Processing System

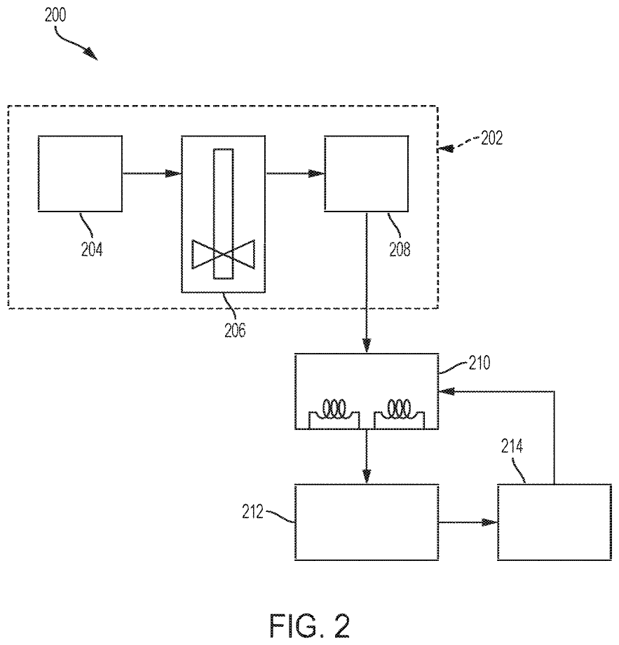

FIG. 2 schematically illustrates aspects of a food processing system 200, in accordance with an embodiment of the disclosure. As illustrated in FIG. 2 the food processing system 200 generally includes a preparation system 202. This preparation system 202 may include a cutting or slicing station 204, a marinade blending station 206, and a marination station 208. Cutting or slicing station 204 may be used when pork, beef, lamb or other animal meat is selected. Fibrous vegetables may also be sliced at the cutting or slicing station 204. Pork, beef, and lamb may be sliced or cut into strips that may be approximately 2-3 inches in length. Chicken breasts may be left intact. Other chicken parts may be sliced if desired, or the meat may be simply removed from the bones. While 2-3 inches is suggested, cutting or slicing size does not affect the end result. The cutting station includes normal chefs knives, however, automated cutting systems may also be suitable, particularly if large batches are prepared.

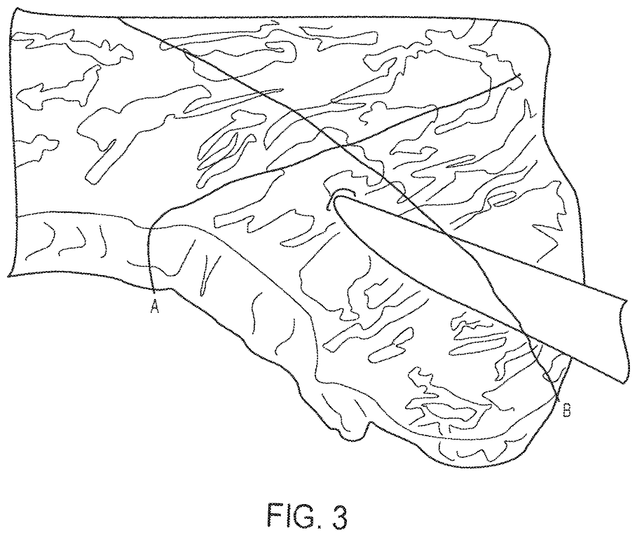

FIG. 3 depicts the possible cutting lines for a cut of beef. Line A is a preferred cutting or slicing line because this line cuts along the muscle lines, resulting in longer strands of meat. During this initial cutting stage excess fat may be trimmed or cut off before further preparation and cooking.

Preparation system 202 in FIG. 2 also includes a marinade blending station 206 for blending selected ingredients to produce a marinade. Marinating typically uses a mix of three components: salt, acid, and a flavoring, however, marinating may use only one or two of the components. Salt acts as a flavor enhancer and penetrates meat. Salt is the only ingredient that penetrates deep into the meat because it is a smaller molecule than water. Salt also reacts chemically and electrically with the water present in the meat. In addition, salt alters meat proteins to allow the meat to hold more water during cooking. Soy sauce may be used in the marinade as a source of salt. Higher concentrations of salt penetrate the meat through the process of osmosis. While salt is added to the marinade, the amount of salt added may be controlled and adjusted to produce a lower sodium shredded dried meat product. While salt is used in the marinade, the amount of salt used is less than found in beef jerky or cured ham products. Acids that may be used in a marinade include fruit juices, vinegar, buttermilk, yogurt, and even sugar-free soft drinks. A wide variety of fruit juices such as lemon, apple, white grape, orange and pineapple work well. Vinegars such as cider, sherry, balsamic, raspberry and distilled work well to add flavor. Additional flavorings, including herbs and spices commonly used in cooking may be added to the marinade. Once the marinade is blended the selected meat is marinated in the mixture at marination station 208. The amount of time spent at marination station 208 may vary with the selected meat. Chicken may be marinated with the skin removed for 1-24 hours, while pork and beef may be marinated for at 1-24 hours. Fish may be marinated for approximately 30 minutes to 1 hour.

While marinade adds flavor, it is optional, and a further embodiment may be used to produce a non-seasoned and unmarinated dried shredded meat. In this embodiment, the selected meat may be brined in a mixture of salt and water to ensure that the meat is soft and tender prior to further processing. The brine may be prepared at the marinade blending station 206. During the brining process the fluid naturally present in the meat is exchanged with the salt water through osmosis, resulting in more liquid in the meat.

Once any desired marination or brining is completed, the meat passes to cooking station 210. This initial cooking may be accomplished with slow cooking, baking, steamed, or boiling. During the long initial cooking process, the meat becomes tenders and the water-insoluble collagen that holds the muscle fibers of the meat together is converted to water-soluble gelatin. Commercial slow cookers, ovens, or pressure cookers may be used. If boiling or steaming, the water level should be monitored, or a water level sensor used to ensure correct water levels. The required cooking time will vary depending on the desired degree of tenderness in the final product. Some meats may be cooked for as little as a few minutes and may be cooked for up to 24 hours, with oxtail being just one example of a meat that becomes more tender with longer cooking times. Depending on the meat, cooking time is based on how much collagen needs to break down to water soluble gelatin, or how tender the meat was before it was cooked. Typically, the desired state of tenderness allows the meat to be pulled apart using fingers or a fork, hook, or similar tool. In this state the muscle fibers are easily broken apart. Fish does not require slow cooking, pressure cooking, or long boiling periods as it contains lower collagen and elastin levels. Fish should be initially cooked by normal frying or baking methods.

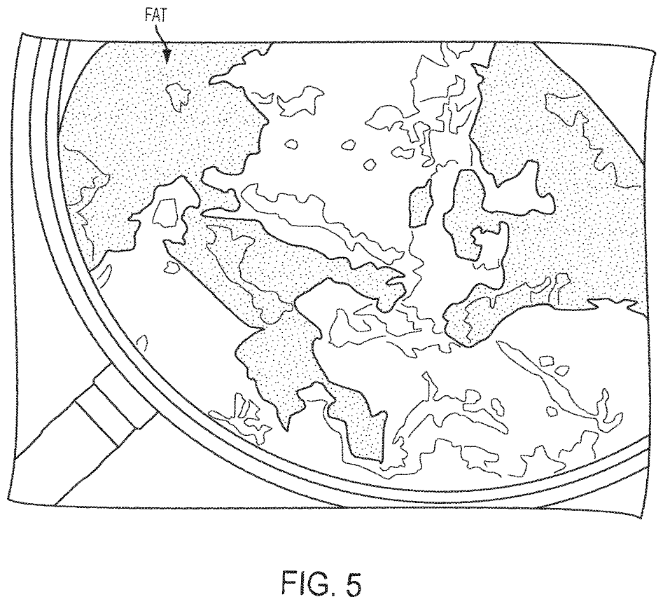

After the initial cooking the meat may be set to cool, at cooling station 212. The cooling may take place in a refrigerator or commercial cooling unit. If removing fat and oils from the cooking juice is desired, refrigeration may be chosen, as the oil will solidify for easier removal in the cooler air of a refrigeration unit. The solidified fat and oils may be scooped from the container. The meat may be removed from the cooking pan and additional fat may be removed at this time, while still soft and easy to remove from the meat. This is illustrated in FIG. 5. The liquid remaining at this stage should be reserved for the second cooking stage. This liquid is comprised of the marinade and any juices resulting from the cooking process.

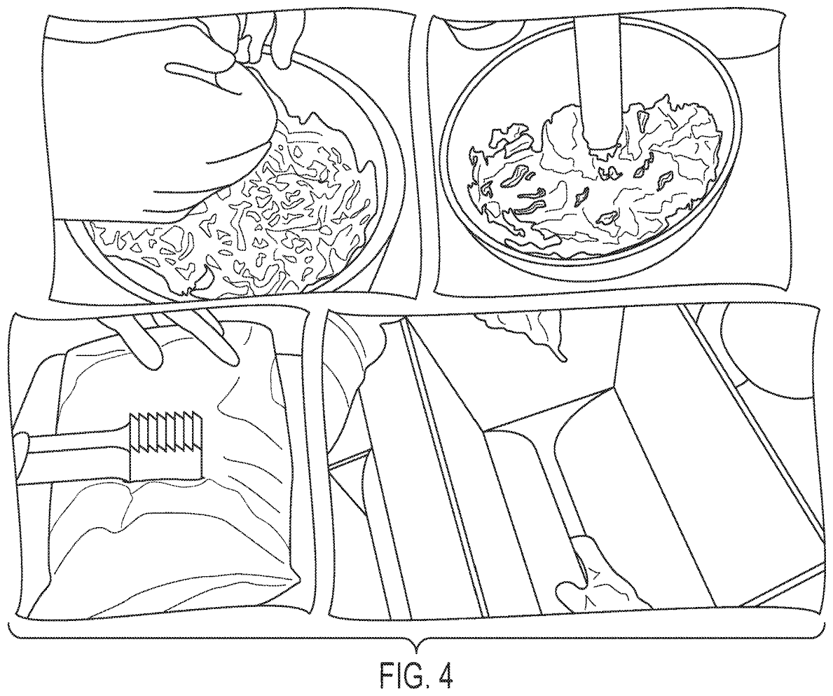

The meat may be finely shredded immediately after cooking if the optional cooling is not selected. The shredding occurs after the optional fat and oil removal process. This shredding takes place at shredding station 214 and is shown in FIG. 4. FIG. 4 also depicts methods that may be used to perform the shredding operation. In this step the meat is placed in a bowl or other container and is pounded with a wooden stick or mallet. The wooden stick is also used to spread apart the fibers of the meat. It may be useful to place the meat in a plastic bag during this stage to simplify clean-up and to ensure that the product is not contaminated. These options are illustrated in FIG. 4. Commercial meat shredders can also be another option to shred the meat.

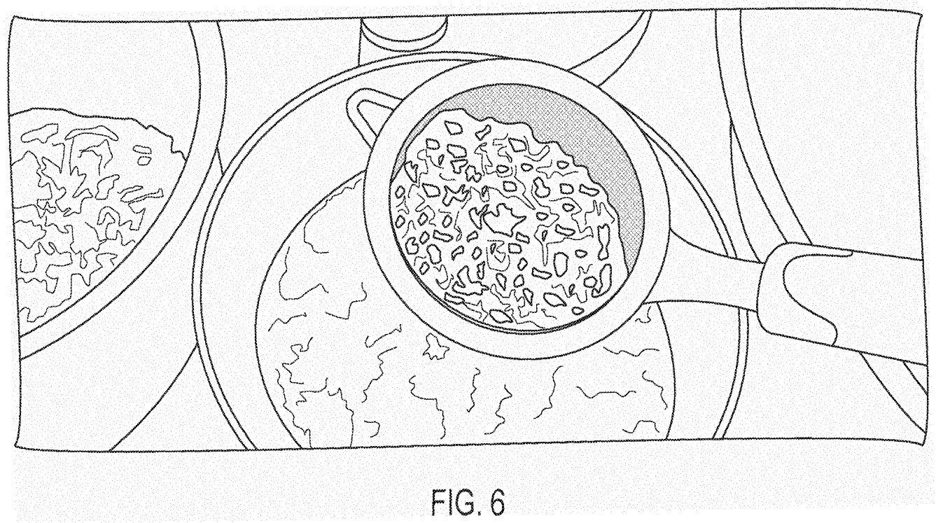

After shredding the meat, it can immediately be baked or placed in a frying pan for further processing to remove moisture. At this point, it is possible to add more flavor or break down the fibers further. To accomplish these goals, the meat is boiled with the original marinade and/or other additional seasonings. The boiling may be accomplished at cooking station 210. If desired, additional spices and flavorings may be added to the reserved liquid to further enhance or vary the flavor. The de-fatting process may be cooled for 2-5 hours depending on the amount of liquid. The reserved liquid may be strained to remove any excess herbs and spices, as shown in FIG. 6. If desired, another flavoring may be used in place of the reserved liquid for a variation in flavor.

Once the boiling is complete, the meat is baked, placed in a frying pan, or similar commercial kitchen appliance, with little to no oil for a second cooking. This second cooking may use the cooking station 210. The meat may be monitored so that it is cooked evenly. Additional flavors & juices may also be added during this process. It is contemplated that an automatic cooking system may be used that provided for holding the meat in a first position and then turning to a second position, to avoid burning or over-cooking. The meat may be pressed lightly during this second cooking. The goal is to avoid drying out the meat and excess pressure would result in a dried out product. At the desired finished state there is little sizzle and steam and has a slightly soft texture. It not hard, or unyielding to the touch. The finished product leaves very little moisture on tools or hands and will bounce back when lightly pressed. The final product should not be fine or have a cotton candy texture like meat floss. It will look more like dried shredded meat. but not so hard and dry like beef jerky.

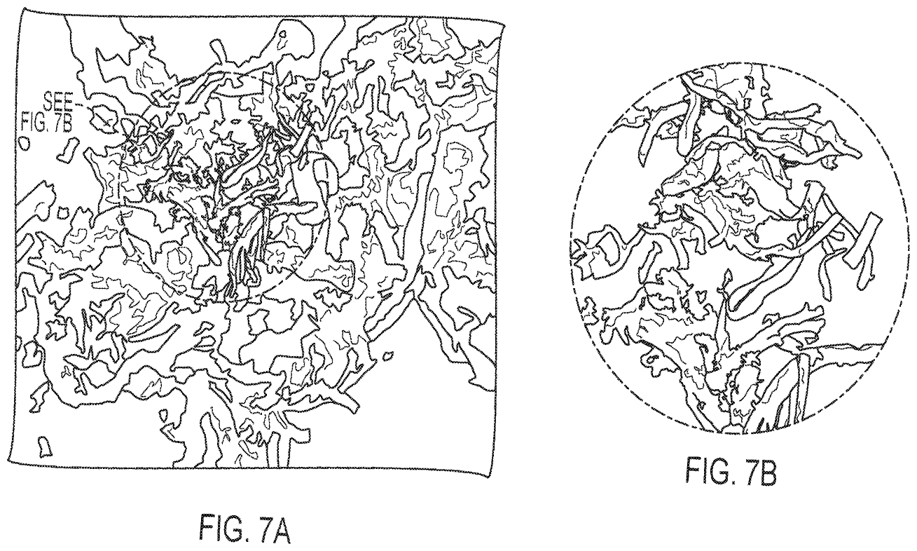

FIG. 7A shows the finished product and FIG. 7B shows a close up of the finished product. The meat still retains the strand structure of meat but will bounce back when pressed. These shreds may be eaten with no additional water or heating and may be added to soups, salads, or sandwiches as desired. The finished product may be stored or packaged in an airtight container to preserve freshness. For maximum storage life the finished meat shreds may be packaged in a vacuum sealed package. The product is sufficiently dry that it keeps well without packaging. Storage life may be extended by storing in a refrigerator after opening.

A further embodiment provides for processing fibrous vegetables using the same process described above for meats. When processing vegetables, the amount of time required for the initial and second cooking stages may vary from the timings suggested for animal meats. Note that some vegetables will skip the [104] cooking process and immediately be shredded as described above.

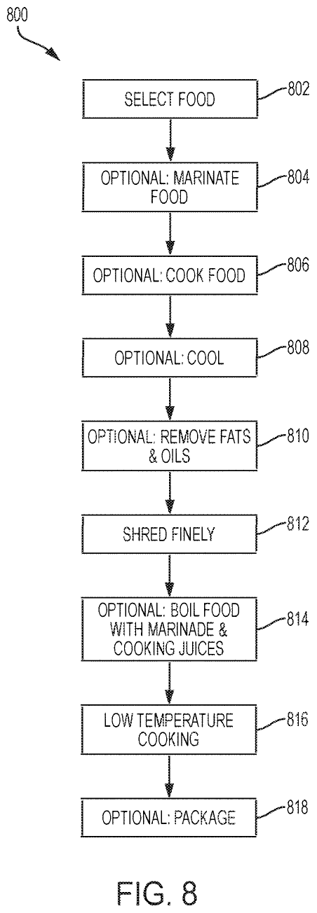

FIG. 8 provides a flowchart of a method of preparing shredded dried food products in accordance with the embodiments described herein. The method, 800, may be used with animal meats or fibrous vegetables. In step 802 the food is selected. The selection may be animal meats or fibrous vegetables. If additional flavor is desired, then in optional step 804, the food is marinated. This marinade may be chosen to add particular flavorings to the food or may be selected to enhance the natural flavor. The food is cooked in a first cooking process 806. This first cooking process is optional and may not be needed for foods that do not require multiple cooking stages to reach a desired tenderness. The cooking process selected may be boiling, baking, steamed, pressure cooking or slow cooking and is chosen to tenderize the food and break down the fibers. In optional step 808 the food may be cooled. In optional step 810 fats or oils may be removed from the food. At this point, any marinade may be strained and retained for further use. The food is then shredded finely in step 812. Then, in step 814 the food may be boiled with the reserved liquid from step 808, or an additional liquid may be chosen for the boiling. Next, in step 816, a second, low-temperature cooking is performed. This low-temperature cooking is performed to dry the food to a desired level of dryness. This level may range from 5%-99% moisture. The moisture level may be selected based on the intended storage period, or desired flavor or texture. At step 818 the finished product may be packaged if desired.

The shredded dried food product may be used as a topping or filling in many popular dished and offers a quick and easy way to add nutrition and flavor to fast meals. In addition, the shredded dried food product provides numerous advantages: it is all natural and non-refrigerated; very low in fat and oils; depending on flavorings and marinades may provide a lower-sodium alternative to jerky or meat chews; and does not require any pre-heating before use.

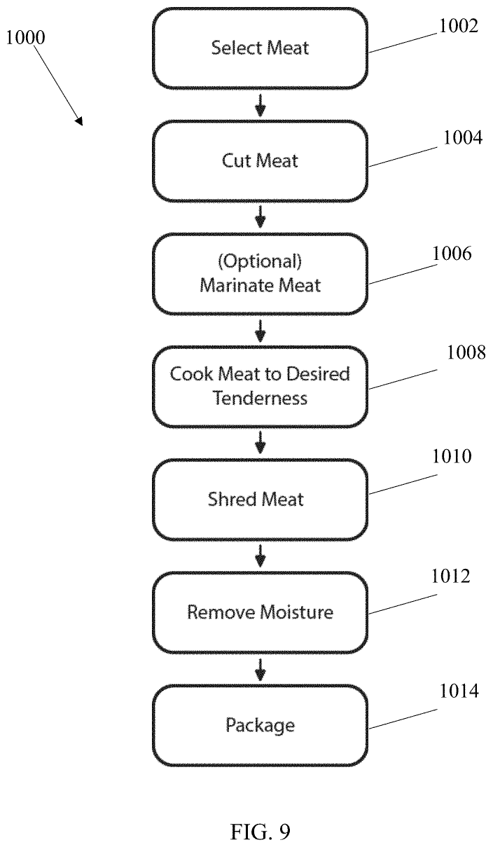

FIG. 9 is a flow diagram of one embodiment of the method of producing a shredded and dried food product. The steps, which are preferably performed in this order, may comprise: selecting the meat 1002; cutting the meat 1004; marinating the meat (optional) 1006; slow cooking the meat 1008; shredding the meat 1010; drying the meat/removing the moisture 1012; and packaging the final product 1014.

The meat may be pork, beef, chicken, and the like. Typically, the cut of meat would be a large, lean cut such as pork butt, pork shoulder, brisket, chuck, chicken breast, and the like. The selected meat is preferably cut into pieces, chucks, or cubes that are approximately 2-to-10-inch pieces (5-to-25-cm pieces). This means that, preferably, the pieces of meat are at least 2 inches in length, width, and thickness, and no greater than 10 inches in length, width, and thickness. Before cooking the meat may be marinated overnight or for 1-2 hours in a vacuum tank that rotates the meat. In order to render the meat to the desired tenderness, the meat is slow cooked in liquid in large vessels, such as woks, kettles, and pots, with or without pressure. The meat may be fully and/or substantially immersed in a cooking liquid, such as water, brought to a boil and then simmered at 185° F. to 205° F. (85 C to 96 C) for at least 30 minutes to 8 hours, with a preferred cook time of 1 to 2 hours. and up to 24 hours. A lid may be put on the cooking vessel to prevent drying out or the need to add additional liquid. The contents of the cooking vessel may be stirred occasionally to prevent the meat from sticking to the cooking vessel. The meat is cooked until tender. For purposes of this disclosure to be tender means to be soft and giving, such that the meat holds its shape when left alone, but able to be eaten (bitten and chewed) without significant effort or excessive chewing. A piece of meat is tender when it may be divided by the side of a fork and a knife is not needed to complete the division.

Once the meat is tender, the pieces are reduced to smaller units via shredding. The shredding may be done in the cooking liquid or may be removed from the cooking liquid. The shredding may be done by hand or with the use of various devices. Preferably, the shredded meat is shredded until the pieces are between 0.1 centimeters (cm) and 1.8 cm in diameter and represent a clump of muscle fibers. More preferably, the diameter of the shredded meat pieces may be 0.2 to 0.8 cm in diameter. This is much thicker than meat floss, which is less than 0.1 cm thick. Preferably the shredded meat pieces are approximately 1.1 cm to 12.7 cm in length, and more preferably are approximately 1.5 cm to 5.0 cm in length or even to 10.0 cm.

The shredding may be done by hand, tools, and/or machines. The shredding of the meat is done along the length of the muscle fibers (with the grain) and is done without cutting or tearing across the grain. Knives and cutting instruments are preferably not part of shredding for purposes of this disclosure.

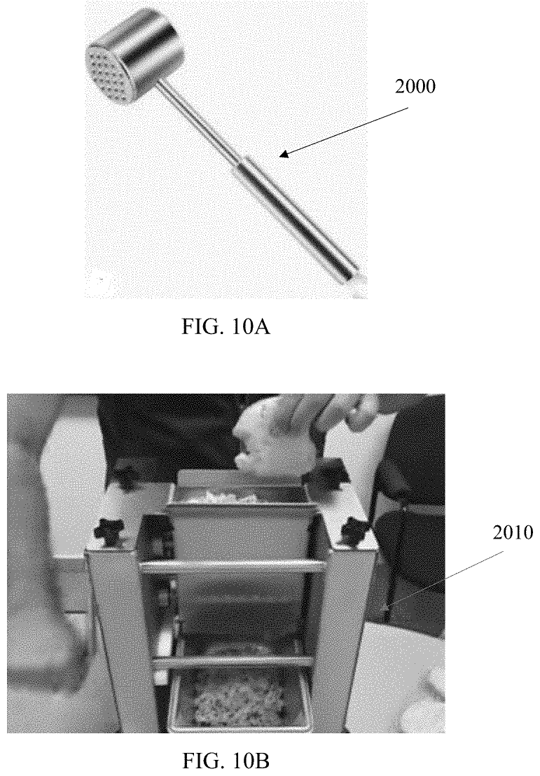

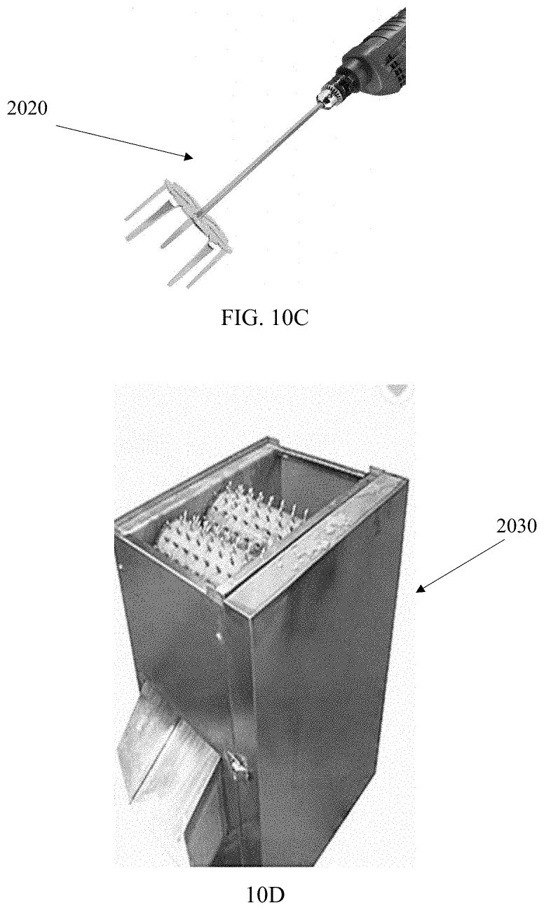

FIG. 10A is an image of one embodiment of a shredding device. A mallet or hammer 2000 may mash the meat to assist with the shredding of the meat.

FIG. 10B is an image of another embodiment of a shredding device. FIG. 10B shows a manual rotating shredding machine 2010 that may be used to create the shredded meat of the present disclosure.

FIG. 10C is an image of another embodiment of a shredding device. The device 2020 may be a progged attachment that is attached to a drill and may shred the meat in accordance with some embodiments of the present disclosure.

FIG. 10D is an image of another embodiment of a shredding device. The device 2030, which is an automatic and electric meat shredder, may be used to shred the meat of the present disclosure.

Preferably, the meat is shredded when it is hot and has just recently finished cooking.

The removal of moisture may be done by evaporation, de-humidifying, conditioning the air, and/or heating. Preferably, the step of drying the meat/removing the moisture 1012 may be done with a heated and rotating drum/bowl, which cycles and tosses the meat to dry it evenly, and which is referred to as a tumble dryer. The tumble dryer may have a mixing arm in the center that tosses and rotates the meat to dry it evenly. The tumble dryer may be heated to a temperature in the range of approximately 150 F to 250 F, and more preferably, the tumble dryer is set at a temperature of approximately 200 F. Preferably, the shredded meat product is heated and tumbled in the tumble dryer for approximately 45 minutes to 2 hours. More preferably the shredded meat product is in the tumble dryer for approximately 1 to 1.5 hours. The meat should be checked periodically to ensure that it is not being over dried.

In another embodiment, the meat may be dried in an oven with trays that have holes to circulate air evenly, or mesh trays with an added mesh sheet on top.

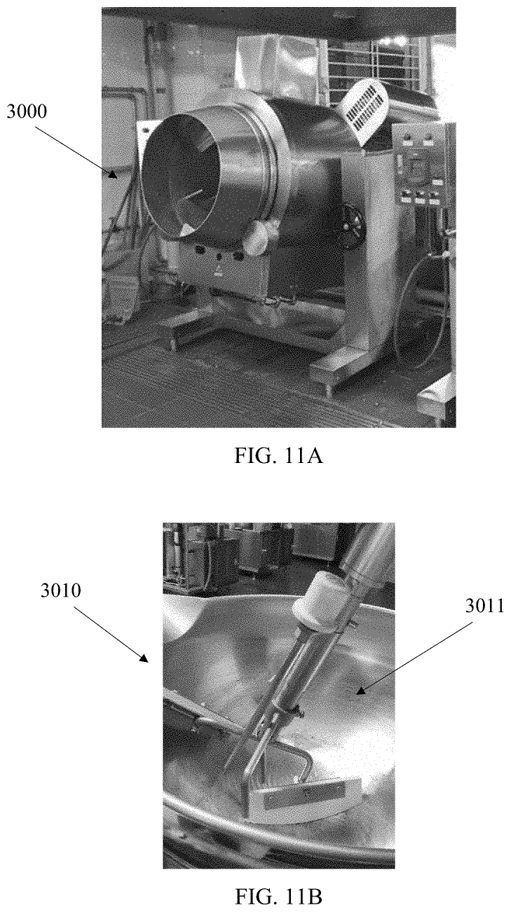

FIG. 11A is an image of one embodiment of a tumble dryer 3000 showing a heated drum/bowl.

FIG. 11B is an image of another embodiment of the tumble dryer 3011 that shows a mixing arm 3010. Tumble dryer 3011 is a static drum/bowl that heats and dries the meat while the mixing arm 3010 tosses and rotates the meat to dry it evenly.

Preferably the shredded meat is drained of any excess moisture and then added to the tumble dryer 3000/3011. While meat is rotating, the meat may be handled and further broken up to prevent clumping. The meat is done drying when it has a moisture to protein ratio (MPR) of 0.76:1 to 1.59:1. Typically, to achieve this MPR, the meat may be heated and tumbled for 1 to 1.5 hours. Preferably, the meat will turn golden brown when it is done. In some embodiments, the meat is dried until it meets USDA standard of a water activity to be under 0.85 to ensure that it is shelf-stable. Additional seasonings can be added while the meat is cooking in the tumbler. Once the meat has a good color, preferably the heat is turned off, but the tumbler is left on to allow the meat to further dry while rotating and allow for additional mixing of the seasonings, if any have been added. The total time for heating and tumbling may be based on the meat quality, meat type, and the initial level of moisture. The meat moisture levels should be checked frequently to avoid over drying the meat.

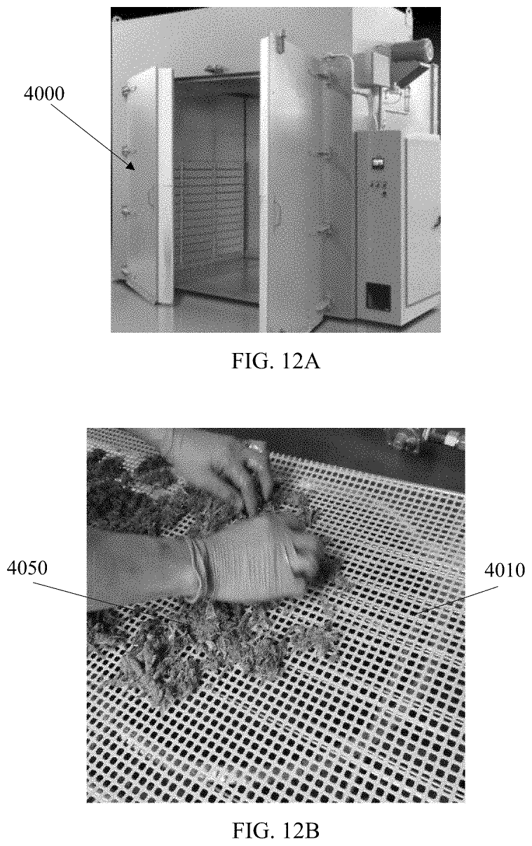

FIG. 12A is an image of a one embodiment of an oven. The oven 4000 is one example of an oven that may be used to remove moisture from the meat.

FIG. 12B is an image of a one embodiment of an oven rack 4010, which has holes that allow the meat 4050 to dry evenly.

If an oven is used to dry the shredded meat, the rack, trays, and/or mesh sheets may have holes that allow air circulation to evenly dry the shredded meat. The holes are preferably smaller than the pieces of meat so that the meat does not fall through, but big enough to ensure air is circulating appropriately. To ensure all the meat is evenly is dried, the meat may be tossed and turned during the process (by hand or using a turning tool).

Preferably the oven is set at a temperature in the range of approximately 150 F to 250 F, and more preferably, the oven is set at a temperature of approximately 200 F. Preferably, the shredded meat product is baked in the oven for approximately 45 minutes to 2 hours. More preferably the shredded meat product is baked in the oven for approximately 1 to 1.5 hours. The meat should be checked periodically to ensure that it is not being over dried.

Once the meat is finished drying, it may be removed from the dryer and spread on a surface to be cooled.

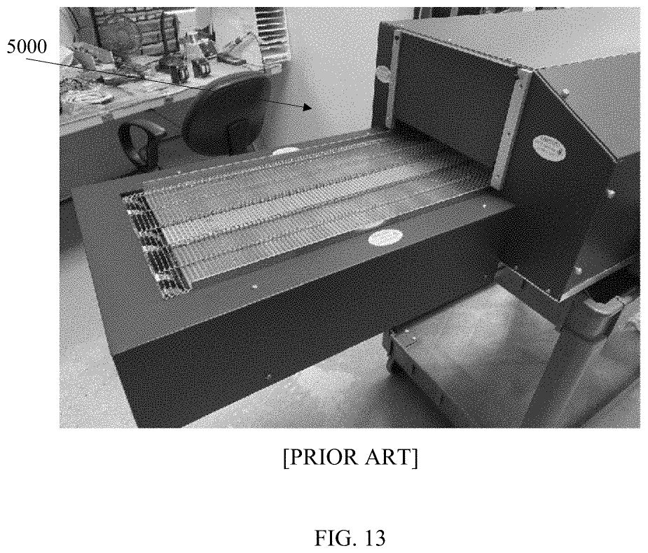

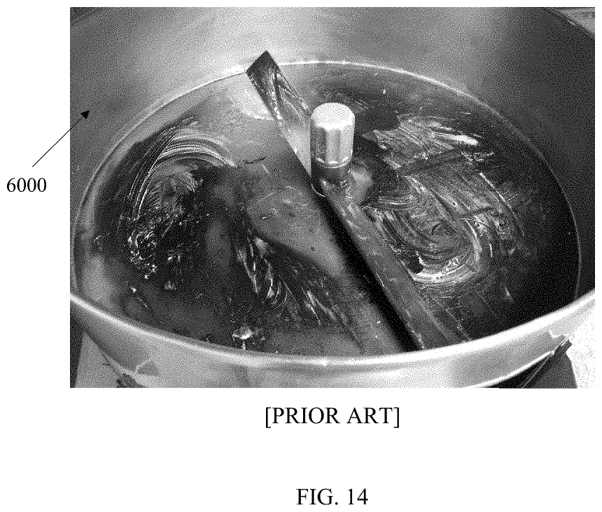

FIG. 13 is an image of a prior art conveyor heater. The machine 5000 is not appropriate for drying in accordance with the method of the present disclosure. The conveyor holes are too large.

The product of the present disclosure is different than jerky products and cannot be made using jerky methods and tools. It cannot be heated on a rack with no holes. It cannot be hung from hooks or racks,

A typical conveyor belt oven, which often used for cooking pizza or making jerky has long gaps in the grate and a short cooking period, which are not acceptable for making the product of the present disclosure.

FIG. 14 is an image of a prior art meat floss machine. The meat floss machine 6000 has blades that are about 1 millimeter above the bottom of the container of the machine. When the meat is added the meat is obliterated into very fine strands, which are then agitated to create a cottony, fluffy texture. Use of a meat floss machine will never result in a meat that has the same size, shape, and texture as the shredded meat of the present disclosure.

Preferably, the final product that results from the method of the present disclosure has the following properties: Moisture percentage—greater than 5% (determined by (sample weight−dried weight)/sample weight×100); Water Activity−0.41 to 0.85, and more preferably 0.45 to 0.80; and MPR of 0.76:1 to 1.59:1.

For purposes of this disclosure, “moisture percentage” is defined as loss of sample weight after drying. Samples are weighed and then placed in an oven to be dried. Samples are removed from the oven and reweighed and the loss of sample weight is calculated as moisture. Equation to determine % moisture=(sample weight−dried weight)/sample weight*100.

For purposes of this disclosure, “water activity” or “AW” is defined as the ratio between the vapor pressure of the food itself, when in a completely undisturbed balance with the surrounding air media, and the vapor pressure of distilled water under identical conditions. Water activity is not the water content, but rather a measure of the water in the food that is available to microbes. When meat is salted, the water is drawn to the salt and mostly becomes ‘unavailable’ to microbes. Then if the meat is dried, much of the remaining water is lost (via steam or evaporation), so that the Water Activity of the food drops far below the level needed to sustain microbial reproduction or toxin production. If sodium nitrate (saltpeter) has been added, the ability of bacteria to survive is further reduced. This is the environment of the original jerky and dried meats that have been prepared, processed, stored, and eaten for thousands of years. Most foods have a water activity above 0.95 and that will provide sufficient moisture to support the growth of bacteria, yeasts, and mold. The amount of available moisture can be reduced to a point which will inhibit the growth of the organisms. If the water activity of food is controlled to 0.85 or less in the finished product, it is less regulated by the U.S. Government.

For purposes of this disclosure, “moisture to protein ratio” and “MPR” are defined as the moisture content of a food product and dividing it with the protein content of that same product. This is well known ration related to food regulation in the United States. https://www.fsis.usda.gov/sites/default/files/import/Labeling-Policy-Book.pdf.

Table 1 is a Comparison of the final properties of the product of the present disclosure, meat floss, and jerky. This shows how very different the final product is from meat floss and jerky, which makes sense because the methods to create each of these three final products is very, very different.

| | Product of the | | |
|---|---|---|---|
| | present disclosure | Meat Floss | Jerky |
| Texture | Dried Pulled Pork | Cotton, fluffy, | Lean trimmed meat |
| Similar To | | filaments | that has been cut |
| | | | into strips and |
| | | | dried |
| Description | Clumps of fibers | 1-3 muscle fiber | Thin slices of meat |
| of outward | in thin strips with | strands per piece. | cut against the |
| appearance | the grain. | | grain. |
| Moisture | 5% and up | ≤1-4% | 5% and up |
| Content | | | |
| Moisture to | Ranges from | 0.75:1 or less | 0.75:1 or less |
| Protein | 0.76:1 to | | |
| Ratio | 1.59:1 | | |
| (MPR) | | | |
| Water | Ranging from 0.4 | Under 0.4 | .85 and lower |
| Activity | to 0.85 | | |
| Yield Ratio | >5:1 (starting | Approximately | Approximately |
| | with 5 kg of meat | 5:1 | 3:1 |
| | results in greater | | |
| | than 1 kg of | | |
| | final product) | | |
| Placing | Retains its | Substantially | Within a minute, |
| final | general | dissolves and is | retains its |
| product in | structure and | unrecognizable, | structure, and |
| Water | becomes soft | clumpy, and very | does not get |
| | and tender | soft within | tender or soft. |
| | within | seconds. | |
| | seconds. | | |
| Storage | Shelf stable for | No expiration | Shelf stable for |
| Life | 1 year. | date due to the | 1 year. |
| | Should be | very low moisture | Should consume |
| | consumed within | levels | within a few days |
| | a few days | | after opening or |
| | after opening or | | refrigerate. |
| | refrigerate. | | |
| Weight- | Denser than Meat | Much lighter | Most dense do it |
| based on | floss because of | since there is | be a slice of the |
| the surface | clumps of fiber, | air within each | entire meat |
| area | but less than | fiber | |
| | jerky | | |
| Pea of Soy | None added | Typically added | None added |
| Flour | | | |

The above-detailed embodiments of the disclosure are not intended to be exhaustive or to limit the disclosure to the precise form discussed above. Specific embodiments of, and examples for the disclosure are described above for illustrative purposes, but those skilled in the relevant art will recognize that various equivalent modifications are possible without deviating from the disclosure. For example, although the above-noted steps are presented in a given order, alternative embodiments may perform the steps in a different order. Moreover, aspects of the various embodiments described herein can be combined to provide further embodiments.

Unless the context clearly requires otherwise, throughout the description and the claims, the words “comprise,” “comprising,” and the like are to be construed in an inclusive sense as opposed to an exclusive or exhaustive sense, i.e., in a sense of “including, but not limited to.” Use of the word “or” in reference to a list of items is intended to cover: (a) any of the items in the list; (b) all of the items in the list; and (c) any combination of the items in the list.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for preparing a shelf-stable meat product, comprising the steps in this order:
providing at least one piece of meat;
cutting said at least one piece of meat, such that there is a plurality of cut pieces of meat;
wherein said plurality of cut pieces are approximately two-to-ten-inch pieces (5-to-25-cm pieces);
cooking said plurality of cut pieces of meat in cooking liquid in a cooking vessel, such that there is a plurality of cooked and cut pieces of meat;
shredding said plurality of cooked and cut pieces of meat, such that there is a plurality of cut, cooked, and shredded pieces of meat; and
removing moisture from said plurality of cut, cooked, and shredded pieces of meat, such that a shredded and dried meat product is produced.

2. The method of claim 1, further comprising:
marinating said cut pieces of meat before cooking said cut pieces of meat.

3. The method of claim 1, further comprising:
seasoning said plurality of cut, cooked, and shredded pieces of meat before removing moisture.

4. The method of claim 1, wherein said plurality of cut pieces of meat are cooked substantially submerged under said cooking liquid for at least 0.5 hours at approximately 185 F to 205 F (85 C to 96 C).

5. The method of claim 1, wherein said plurality of cut pieces of meat are cooked until tender.

6. The method of claim 1, wherein said plurality of cut, cooked, and shredded pieces of meat are approximately 0.2 cm to 0.8 cm in diameter and are approximately 1.1 cm to 12.7 cm in length.

7. The method of claim 1, wherein said plurality of cut, cooked, and shredded pieces of meat are approximately 1.5 cm to 10.0 cm in length.

8. The method of claim 1, wherein said removing moisture step is via a tumble dryer that cycles and tosses said plurality of cut, cooked, and shredded pieces of meat.

9. The method of claim 8, wherein said tumble dryer comprises a mixing arm that tosses said plurality of cut, cooked, and shredded pieces of meat.

10. The method of claim 9, wherein said tumble dryer is heated to a temperature in the range of approximately 150 F to 250 F.

11. The method of claim 10, wherein said tumble dryer is heated to a temperature of approximately 200 F.

12. The method of claim 9, wherein said plurality of cut, cooked, and shredded pieces of meat are heated and tumbled in said tumble dryer for approximately 45 minutes to 2 hours.

13. The method of claim 12, wherein said plurality of cut, cooked, and shredded pieces of meat are heated and tumbled in said tumble dryer for approximately 1 to 1.5 hours.

14. The method of claim 1, wherein said removing moisture step is via an oven.

15. The method of claim 14, wherein said oven is heated to a temperature in the range of approximately 150 F to 250 F.

16. The method of claim 15, wherein said oven is heated to a temperature of approximately 200 F.

17. The method of claim 14, wherein said plurality of cut, cooked, and shredded pieces of meat are heated in said oven for approximately 45 minutes to 2 hours.

18. The method of claim 17, wherein said plurality of cut, cooked, and shredded pieces of meat are heated in said oven for approximately 1 to 1.5 hours.

19. The method of claim 1, wherein said shredded and dried meat product has a moisture to protein ratio in the range of approximately 0.76:1 to 1.59:1.

20. A method for preparing a shelf-stable meat product, comprising the steps in this order:
providing at least one piece of meat;
cutting said at least one piece of meat, such that there is a plurality of cut pieces of meat;
wherein said plurality of cut pieces are approximately two-to-ten-inch pieces (5-to-25-cm pieces);
cooking said plurality of cut pieces of meat in cooking liquid in a cooking vessel, such that there is a plurality of cooked and cut pieces of meat;
shredding said plurality of cooked and cut pieces of meat, such that there is a plurality of cut, cooked, and shredded pieces of meat;
removing moisture from said plurality of cut, cooked, and shredded pieces of meat, such that a shredded and dried meat product is produced;
wherein said plurality of cut pieces of meat are cooked substantially submerged under said cooking liquid for at least 0.5 hours at approximately 185 F to 205 F (85 C to 96 C);
wherein said plurality of cut pieces of meat are cooked until tender;
wherein said plurality of cut, cooked, and shredded pieces of meat are approximately 0.2 cm to 0.8 cm in diameter and are approximately 1.1 cm to 12.7 cm in length;
wherein during said removing moisture step said plurality of cut, cooked, and shredded pieces of meat heated to a temperature in the range of approximately 150 F to 250 F for approximately 1 to 1.5 hours; and wherein said shredded and dried meat product has a moisture to protein ratio in the range of approximately 0.76:1 to 1.59:1.
